(19) United States
(12) Patent Application Publication
(10) Pub. No.: US 2016/0236157 A1
(43) Pub. Date: Aug. 18, 2016

(54) Bottle Attachable Decanting Aerator Apparatus

(71) Applicant: Martin G. Casino, Yorktown Heights, NY (US)

(72) Inventor: Martin G. Casino, Yorktown Heights, NY (US)

(21) Appl. No.: 15/008,743

(22) Filed: Jan. 28, 2016

Related U.S. Application Data
(60) Provisional application No. 62/115,883, filed on Feb. 13, 2015.

(51) Int. Cl. B01F 3/04; B01F 5/06

(52) U.S. Cl. CPC B01F 3/0446; B01F 5/0687

(57) ABSTRACT

A bottle attachable decanting aerator apparatus includes a spout member insertable into a mouth of a bottle. The spout member includes a removed section disposed upon a top side thereof and a regulator portion rotationally positional upon the spout member to overlie and alternately reveal the removed section. A conical end piece is sized to fit into the mouth of an existing bottle and a rubberlike exterior disposed thereon sealably engages in the bottle mouth. Liquid poured from the bottle is thus caused to travel under action of gravity through a filamentous tangled wadding disposed interior to the spout member, and position of the regulator portion between a closed position and an open position, enables adjustable inflow of ambient atmosphere between a minimum inflow and a maximum inflow to effect aeration of the liquid during the act of pouring.

### BACKGROUND OF THE INVENTION

Various types of decanting and aerator apparatuses are known in the prior art. Most make use of the Venturi effect whereby a narrowing of some channel decreases pressure in a fluid flowing through said narrows to create a partial vacuum and introduce a stream of air into the fluid by passage of said fluid proximal some aperture or opening. Such practice increases the rate of flow of the fluid as said fluid passes through the narrows.

What is needed is a bottle attachable decanting aerator apparatus that impedes and apportions liquid during the act of pouring to increase the exposed surface area of the liquid for contact with the ambient atmosphere, wherein the partial vacuum created by virtue of pouring the liquid introduces ambient atmosphere controllably and more effectively into the liquid and a greater controllable aeration is effected thereby.

### FIELD OF THE INVENTION

The present invention relates to a bottle attachable decanting aerator apparatus having a spout member attachable sealably into the mouth of a bottle, said spout member having an open channel therethrough, wherein a filamentous tangled wadding, having a plurality of nonporous filaments in amorphous and irregular array, is dispositional interiorly to the spout member, wherein flow of liquid through the wadding is bifurcated among a plurality of amorphously and irregularly arranged voids disposed between each of the plurality of nonporous filaments, said liquid thereby apportioned into separate flows increasing surface area of the liquid for exposure to ambient atmosphere controllably introducible into the spout member when a regulator portion of the spout member is moved between an open position, and a maximum inflow of atmosphere is enabled, and a closed position, and a minimum inflow of atmosphere is enabled, whereby aeration of wine is effective during the act of pouring a glass.

### SUMMARY OF THE INVENTION

The general purpose of the bottle attachable decanting aerator apparatus, described subsequently in greater detail, is to provide a bottle attachable decanting aerator apparatus which has many novel features that result in a bottle attachable decanting aerator apparatus which is not anticipated, rendered obvious, suggested, or even implied by prior art, either alone or in combination thereof.

The present bottle attachable decanting aerator apparatus has been devised to present novel means of controlling introduction of ambient atmosphere into a liquid concurrent when pouring said liquid from a bottle. Oenophiles typically decant wine to let the wine “breathe” previous to drinking, whereby the full flavor of the wine is enjoyed. Gasses trapped subsequent bottling (such as sulfur oxides) are released and oxidation from exposure to ambient oxygen enables expression of aroma and flavor. Decanting is also purposeful for retaining dregs and sediment. The present bottle attachable decanting aerator apparatus, therefore, enables aeration of wine, or any liquid, during the act of pouring from the bottle, and additionally may impede the flow of dregs, whereby the need of a decanter is obviated.

The present bottle attachable decanting aerator apparatus includes a spout member attachable to the mouth of a bottle. The spout member includes a pouring end and an engagement end. In the example embodiment set forth herein the spout member is cylindrical. An ovoid aperture is disposed at the pouring end, said ovoid aperture disposed in angled section thereat. The ovoid aperture therefore includes a distal lip at an outermost extremity of the pouring end over which liquid is directed when pouring through the spout member.

The spout member therefore has a maximum length measurable along a longitudinal axis between the distal lip at the pouring end and the engagement end. Portions of the spout member proximal this maximum length are collectively termed the “bottom side” of the spout member.

The spout member likewise includes a minimum length measurable along a longitudinal axis between the pouring end, at a position upon the ovoid aperture opposite the distal lip, and the engagement end. Portions of the spout member proximal this minimum length are collectively termed the “top side” of the spout member.

The engagement end includes a circular aperture in transverse section therein. A conical end piece is disposed at the engagement end, said conical end piece having a truncated vertex positional interior to a bottle's mouth. The interior of a bottle's mouth sealably contacts a rubberlike exterior surface disposed upon the conical end piece whereby seepage of liquid between the bottle mouth interior and the exterior of the conical end piece is prevented by contact therebetween. The conical end piece has a diameter increasing from a minimum diameter at the truncated vertex to a maximum diameter disposed around the engagement end of the spout member. The conical end piece is thus disposed to sealably engage into bottles having different sized mouths.

To control airflow into the spout member during use, a regulator portion is rotatably disposed upon the spout member, said regulator portion rotatable around the spout member to cover and alternately uncover at least one opening disposed in the spout member top side. In the example embodiment herein disclosed the regulator portion is generally hemi-cylindrical and the at least one opening is a removed section of the top side of the spout member, said removed section of a size appropriate to enable superposition of the regulator portion overtop said removed section. The regulator portion is thus moveable between an open position, overlying the bottom side of the spout member, and a closed position, sealably enclosing the removed section by superposition thereover upon the top side of the spout member.

A user may, therefore, enable a minimum inflow of ambient atmosphere when pouring by maintaining the regulator portion in the closed position. A user may also enable a maximum inflow of ambient atmosphere when pouring by moving the regulator portion to the open position. A user may further control a desired inflow by position of the regulator portion between the open and closed positions whereby a portion of the removed section is selectively covered.

A filamentous tangled wadding is dispositional interior to the spout member. The filamentous tangled wadding includes a plurality of nonporous filaments disposed in amorphous arrangement whereby a plurality of voids are irregularly presented for through-flow of liquid between said nonporous filaments. Liquid caused to travel through the filamentous tangled wadding is thereby slowed and apportioned through the wadding whereby the surface area of said liquid exposed to ambient atmosphere introducible into the spout member is increased. The filamentous tangled wadding may be rendered of a metal, such as copper or another metal, oxidative of sulfur oxides to improve taste.

The filamentous tangled wadding is separable from the spout member for cleaning, as desired. In the example embodiment herein disclosed, the wadding is removable through the removed section, whereby movement of the regulator portion to the open position enables access to the wadding, and the size of the removed section is large enough to accommodate extraction of the wadding from the spout member and to enable seating of the wadding into the spout member for reuse, as desired.

The interior surface of the spout member may further increase perturbation and chaotic flow of liquid traveled thereover to increase aeration by inclusion of a plurality of pits and valleys, such as, for example, ridges, bumps, protuberances, nodules, and the like, whereby a rough and uneven surface interior to the spout member increases turbulent flow of the liquid for intermixing of the liquid with ambient atmosphere introducible thereinto.

Thus has been broadly outlined the more important features of the present bottle attachable decanting aerator apparatus so that the detailed description thereof that follows may be better understood and in order that the present contribution to the art may be better appreciated.

For better understanding of the bottle attachable decanting aerator apparatus, its operating advantages and specific objects attained by its uses, refer to the accompanying drawings and description.

### BRIEF DESCRIPTION OF THE DRAWINGS

### Figures

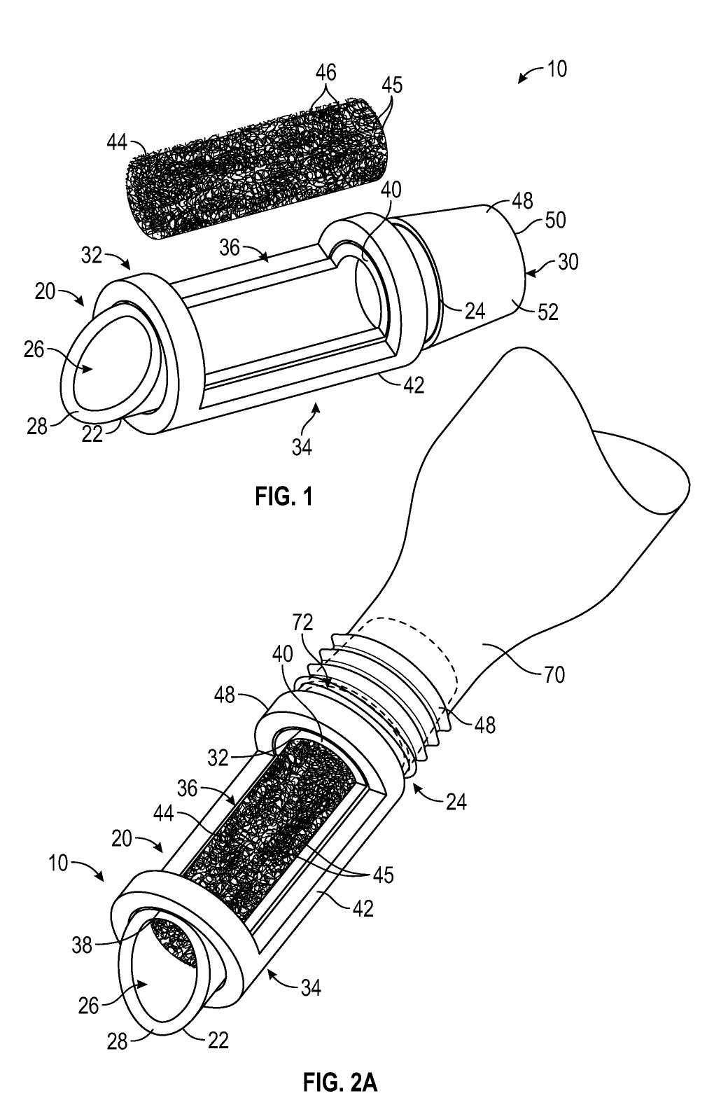

FIG. 1 is an isometric view of an example embodiment.

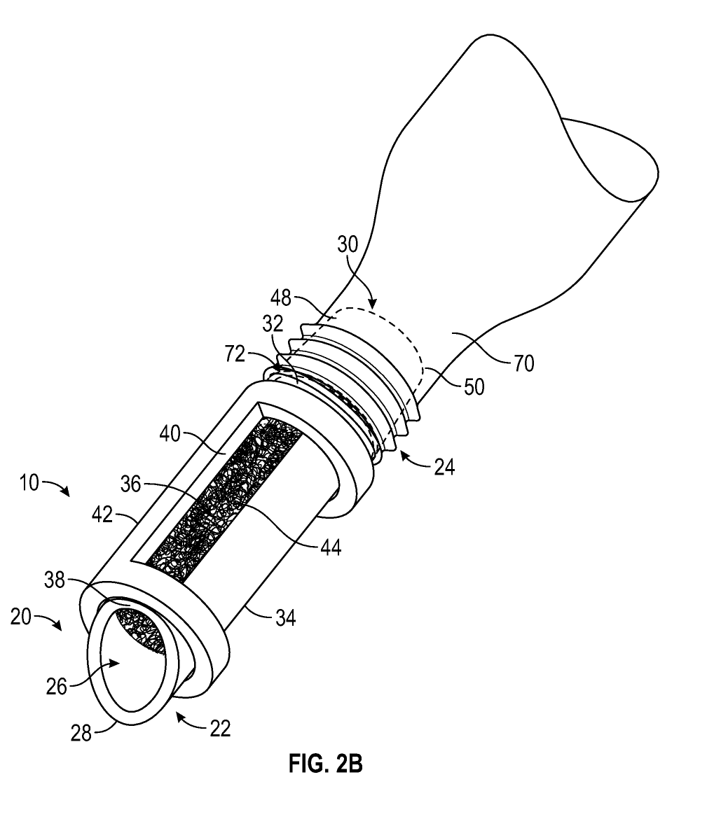

FIG. 2A is an in-use view of an example embodiment inserted into a bottle neck, said example embodiment having a regulator portion disposed in an open position.

FIG. 2B is an in-use view of an example embodiment inserted into a bottle neck, said example embodiment having the regulator portion disposed in between an open position and a closed position.

FIG. 2C is an in-use view of an example embodiment inserted into a bottle neck, said example embodiment having the regulator portion disposed in a closed position.

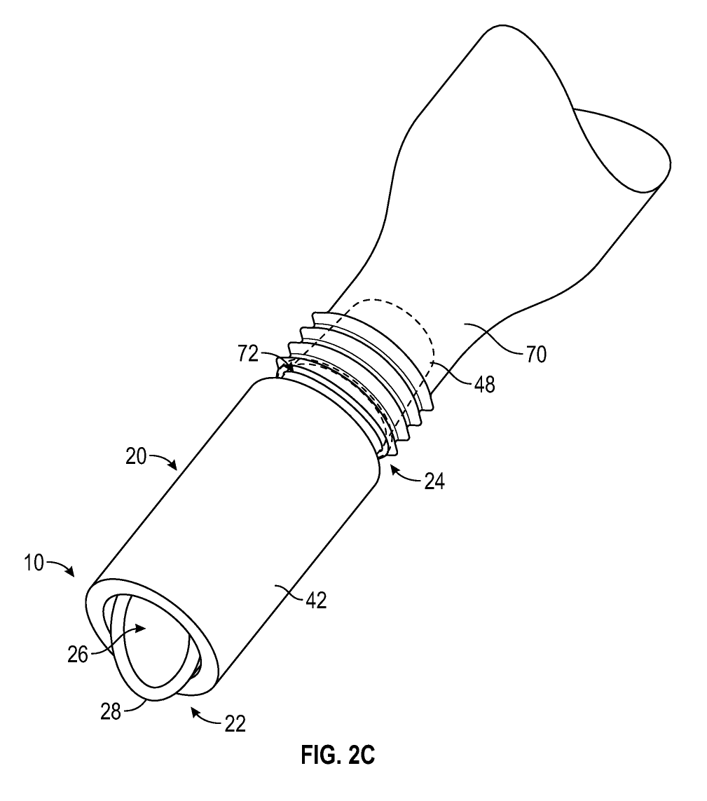

FIG. 3 is an exploded view of an example embodiment.

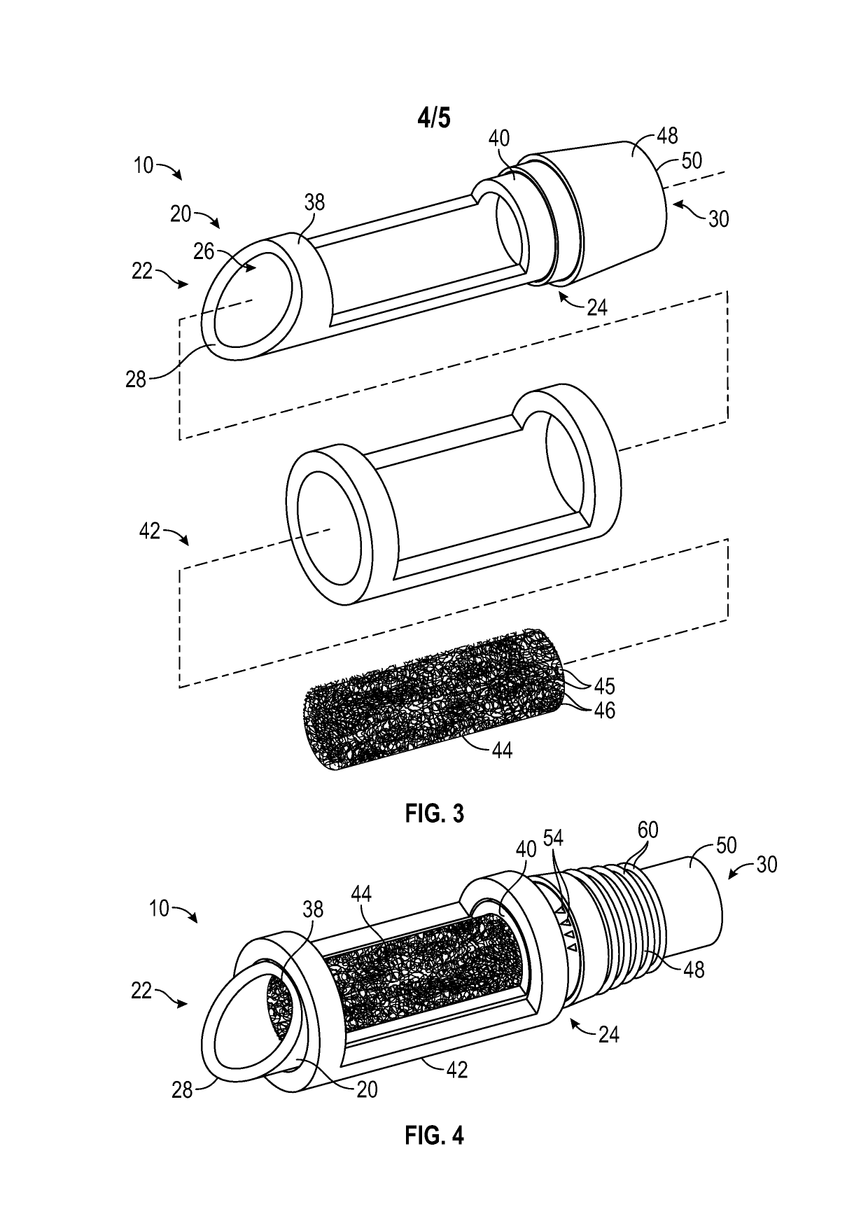

FIG. 4 is an isometric view of an example embodiment having the regulator potion disposed in an open position.

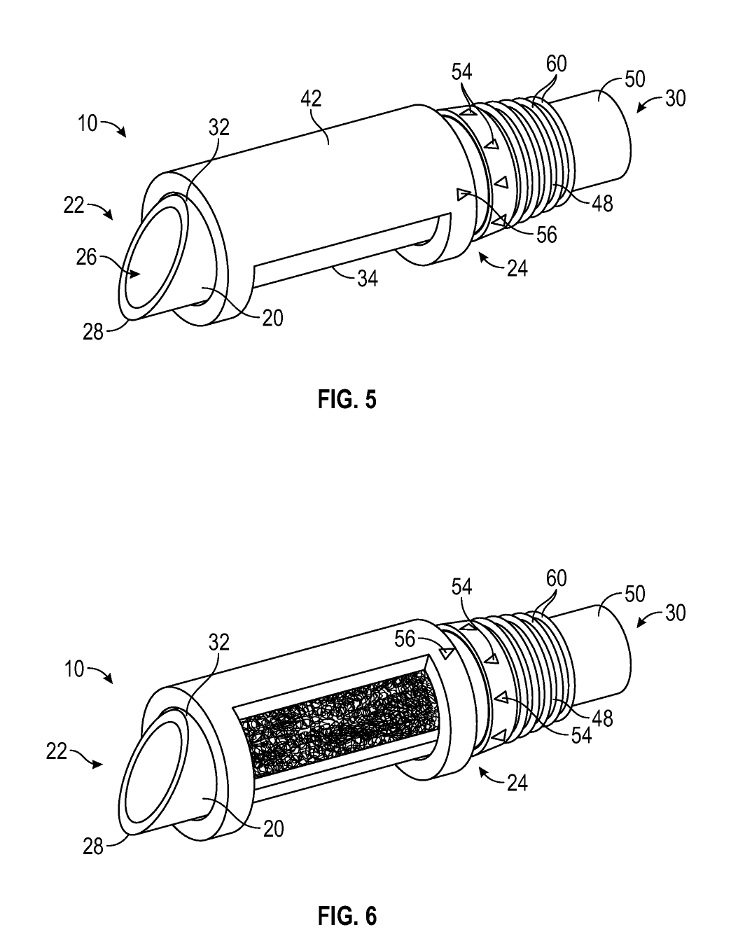

FIG. 5 is an isometric view of an example embodiment having the regulator portion disposed in the closed position.

FIG. 6 is an isometric view of an example embodiment having the regulator portion disposed in between the open position and the closed position.

### DETAILED DESCRIPTION OF THE DRAWINGS

With reference now to the drawings, and in particular FIGS. 1 through 6 thereof, example of the instant bottle attachable decanting aerator apparatus employing the principles and concepts of the present bottle attachable decanting aerator apparatus and generally designated by the reference number 10 will be described.

Referring to FIGS. 1 through 6 a preferred embodiment of the bottle attachable decanting aerator apparatus 10 is illustrated.

The present bottle attachable decanting aerator apparatus 10 has been devised to enable expedient attachment of a spout member 20 into the mouth 72 of a bottle 70 whereby decantation of liquid from said bottle 70 effects direction of the liquid through a filamentous tangled wadding 44 disposed interiorly within the spout member 20, wherein an irregular arrangement of voids enables impeded and circuitous passage of liquid therethrough, and exposure of the liquid to ambient atmosphere introducible into the aerator apparatus 10 is thereby increased. Oxidation of unpalatable compounds present in the wine (such as sulfur dioxides, polyphenols, and other such substances, is thereby enabled during the act of pouring. Oxidation rates of such unpalatable compounds and substances may be increased when the filamentous tangled wadding is rendered of a metal, such as copper for example.

The present bottle attachable decanting apparatus 10 includes a regulator portion 42 rotatable to proportionately cover and uncover at least one opening disposed in a top side 32 of the spout member 20, whereby an inflow of ambient atmosphere into the spout member 20 is controllable between a maximum inflow and a minimum inflow, as will be described subsequently in this specification.

The present bottle attachable aerator apparatus 10, therefore, includes a spout member 20 having a pouring end 22 and an engagement end 24. In the example embodiment herein illustrated, the spout member 20 is cylindrical and the pouring end 22 includes an ovoid aperture 26 disposed slanted in angled section thereupon, wherein a distal lip 28 is disposed at an outermost extremity thereof. The engagement end 24 includes a circular aperture 30 rendered by a transverse section of the spout member 20.

The spout member 20 therefore includes a maximum length measurable along a longitudinal axis disposed between the engagement end 24 and the distal lip 28 of the pouring end 22, and a minimum length measurable along a longitudinal axis disposed between the engagement end 24 and the pouring end 22 at a position upon the ovoid aperture 26 opposite the distal lip 28. Portions of the spout member 20 proximal the maximum length are collectively termed herein the “top side” 32 and portions of the spout member 20 proximal the minimum length are collectively termed herein the “bottom side” 34. Liquid poured through the spout member 20 is routed by action of gravity and centripetal force imparted by the curvature of the spout member 20 to flow out the pouring end 22 over the distal lip 28 when the spout member 20 is positioned with the bottom side 34 in lowermost situation relative a bottle 70 to which the aerator apparatus 10 is attached.

At least one opening is disposed in the top side 32 of the spout member 20, whereby ambient atmosphere is introducible into the spout member 20 when liquid is poured therethrough. In the example embodiment herein illustrated, the at least one opening is a removed section 36 of the spout member 20. In this embodiment, the removed section 36 defines a rectilinear section cut from the spout member 20 top side 32, between the pouring end 22 and the engagement end 24. A first arch 38 separates the ovoid aperture 26 from the removed section 36 proximal the pouring end 22, and a second arch 40 separates the circular aperture 30 from the removed section 36 at the engagement end 24.

The removed section 36 is selectively coverable by action of a rotatable hemi-cylindrical regulator portion 42 disposed upon the spout member 20. The regulator portion 42 is rotatable around the spout member 20 between a closed position and an open position to respectively cover and uncover the removed section 36. The removed section 36 is thus sealably enclosable when the regulator portion 42 is moved to the closed position, whereby a minimum inflow of ambient atmosphere is effected when liquid decanting through the spout member 20 creates a partial vacuum therein, and the removed section 36 is thus alternately revealable when the regulator portion 42 is disposed in the open position, whereby a maximum inflow of ambient atmosphere is effected when liquid decanting through the spout member 20 creates a partial vacuum therein. Control of inflow is thereby effective by position of the regulator portion 42 to partially cover the removed section 36, as desired, to control inflow between said maximum and minimum inflows.

A filamentous tangled wadding 44 is dispositional within the spout member 20. The filamentous tangled wadding 44 presents an irregular and amorphous arrangement of voids 45 disposed circuitously between a plurality of nonporous tangled filaments 46 whereby liquid is impeded and caused to flow tortuously through said voids 45, decreasing the rate of flow of the liquid through the spout member 20 while increasing exposure to ambient atmosphere introducible into the spout member 20 during pouring. Additionally, in embodiments where the tangled wadding 44 is rendered of metal, such as copper for example, contact with the nonporous tangled filaments 46 may increase oxidation of unpalatable compounds. The tangled wadding 44 is readily removable from the spout member 20, and may be seated within the spout member 20 and removed therefrom when the regulator portion 42 is moved to the open position or, alternately in some embodiments, by sliding the tangled wadding 44 out either the engagement end 24 or pouring end 22, as desired.

A conical end piece 48 is additional to the spout member 20 at the engagement end 24. The end piece 48 includes a truncated vertex 50 dispositional interior to the mouth of a bottle 70 to which the spout member 20 is attached. The end piece 48 includes at least one rubberlike exterior 52 disposed to sealably engage against the bottle 70 mouth 72 interior whereby liquid is prevented from seeping between the end piece 48 and the bottle mouth 72 when contact is effected between the bottle mouth 72 interior and the end piece 48 exterior 52. The conical end piece 48 is disposed between a minimum diameter at the truncated vertex 50 and a maximum vertex proximal the engagement end 24 of the spout member 20, whereby the end piece 48 is effective for sealable contact with bottles having different sized mouths.

In the example embodiment shown in FIGS. 4, 5, and 6, the at least one rubberlike exterior 52 includes a plurality of rubberlike rings 60 disposed around the conical end piece 48. Each of the rubberlike rings 60 has a different diameter, and each rubberlike ring 60 may be seated in a corresponding ring channel [not shown] circumscribed into the end piece, said ring channel disposed to maintain position of each of said rubberlike rings 60 appropriate for engagement interior to a bottle mouth 72. In these embodiments, indicia 54 is disposed upon the end piece 48 wherein position of the regulator portion 42 between the open position and the closed position is perceptible to a user at discrete proportions when a regulator indicium 56 is aligned appropriate thereto; for example aligning the regulator indicium 56 with appropriate indicia 54 may signal that the regulator portion is fully closed (FIG. 5), a quarter open, half open, three-quarters open (FIG. 6), and fully open.

The end piece 48 may also be attachable to the engagement end 24 of the spout member 20, enabling disassembly of the spout member 20, end piece 48, and tangled wadding 44 for purposes of rinsing and cleaning between uses. It is further contemplated as part of this invention that the interior surface of the spout member 20 may include a plurality of pits and valleys, ridges, protuberances, or other rough features, to further impede and agitate liquid disposed to flow thereover whereby aeration is increased by action of increased turbulent flow of the liquid through the spout member 20.

What is claimed is:

1. A bottle attachable decanting aerator apparatus comprising a spout member insertable into the mouth of an existing bottle, said spout member comprising:
a pouring end;
an engagement end;
a top side;
a removed section cutaway from the top side;
a regulator portion disposed to rotationally engage over the removed section, said regulator portion dispositional upon the spout member between a closed position overlying the removed section, and an open position not overlying the removed section;
a conical end piece disposed at the engagement end, said conical end piece having a truncated vertex sized fittable into the mouth of an existing bottle;
at least one rubberlike exterior disposed upon the conical end piece, said rubberlike exterior effective of sealable contact between the bottle mouth and the conical end piece; and
a filamentous tangled wadding disposed interior to the spout member, said filamentous tangled wadding disposed between the pouring end and the engagement end;
wherein liquid poured through the spout member is caused to follow a tortuous path through a plurality of voids disposed throughout the filamentous tangled wadding, said liquid exposable to ambient atmosphere when the regulator portion is moved between the closed position and the open position, whereby aeration of liquid is enabled during the act of pouring said liquid from the bottle.

2. The bottle attachable decanting aerator apparatus of claim 1 wherein the pouring end of the spout member further comprises:
an ovoid aperture in angled section; and
a distal lip;
wherein liquid poured through the spout member is caused to flow out of said spout member over the distal lip.

3. The bottle attachable decanting aerator apparatus of claim 2 wherein the spout member further comprises a first arch disposed proximal the pouring end, said first arch disposed between the pouring end and the removed section.

4. The bottle attachable decanting aerator apparatus of claim 3 wherein the spout member further comprises a second arch disposed proximal the conical end piece, said second arch disposed between the engagement end and the removed section.

5. The bottle attachable decanting apparatus of claim 4 wherein the filamentous tangled wadding is removable from within the spout member.

6. The bottle attachable decanting apparatus of claim 5 wherein a regulator indicium is disposed upon the regulator portion, said regulator indicium alignable with indicia disposed upon the conical end piece to signify position of the regulator portion between the closed position and the open position.

7. A bottle attachable decanting aerator apparatus comprising a spout member insertable into the mouth of an existing bottle, said spout member comprising:
a pouring end;
an engagement end;
a top side;
a bottom side;
a removed section cutaway from the top side;
a conical end piece disposed at the engagement end, said conical end piece having a truncated vertex sized fittable into the mouth of an existing bottle;
a first arch disposed upon the spout member proximal the pouring end, said first arch disposed between the pouring end and the removed section;
a second arch disposed upon the spout member proximal the conical end piece, said second arch disposed between the conical end piece and the removed section;
a regulator portion disposed to rotationally engage over the removed section, said regulator portion dispositional upon the spout member between a closed position overlying the removed section, and an open position overlying the bottom side of the spout member;
at least one rubberlike exterior disposed upon the conical end piece, said rubberlike exterior effective of sealable contact between the bottle mouth and the conical end piece; and
a filamentous tangled wadding disposed interior to the spout member, said filamentous tangled wadding disposed between the pouring end and the engagement end, said filamentous tangled wadding comprising a plurality of nonporous filaments delimiting a plurality of voids therebetween;
wherein liquid poured through the spout member is caused to follow a tortuous path through the plurality of voids between the plurality of nonporous filaments comprising the filamentous tangled wadding, said liquid thereby exposable to ambient atmosphere when the regulator portion is moved between the closed position and the open position, whereby aeration of liquid passing through the spout member is enabled during the act of pouring said liquid from the bottle to which the spout member is engaged.
